(19) United States
(12) Patent Application Publication
(10) Pub. No.: US 2007/0153792 A1
(43) Pub. Date: Jul. 5, 2007

(54) Method and apparatus for using FMIPv6 to trigger faster L2 handover

(75) Inventors: Kishore Mundra, Bangalore (IN); Lakshmi Prabha, Bangalore (IN); Sameer Kumar, Bangalore (IN); Wable Raniltsinh Udaysinh, Bangalore (IN)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/647,334

(22) Filed: Dec. 29, 2006

(30) Foreign Application Priority Data
Dec. 30, 2005 (IN) 1979/CHE/2005
Nov. 27, 2006 (KR) 2006-117909

(51) Int. Cl. H04L 12/56

(52) U.S. Cl. 370/390; 370/395.52

(57) ABSTRACT

A method and an apparatus to speed up fast mobile internet protocol version 6 (FMIPv6) by using a relatively fast layer 2 handover. A method and an apparatus to use FMIPv6 to trigger a relatively fast layer 2 handover of a mobile node from an initial access point associated with a previous access router to a neighboring access point associated with a next access router.

### CROSS-REFERENCE TO RELATED PATENT APPLICATIONS

This application claims the benefit of Indian Patent Application No. 1979/CHE/2005, filed on Dec. 30, 2005, in the Government of India Office of the Controller-General of Patents, Designs and Trademarks, and of Korean Patent Application No. 2006-117909, filed on Nov. 27, 2006, in the Korean Intellectual Property Office, the disclosures of which are incorporated herein in their entireties by reference.

### BACKGROUND OF THE INVENTION

1. Field of the Invention

Aspects of the present invention relate to a method and an apparatus to make fast mobile internet protocol version 6 (FMIPv6) relatively faster by using a faster layer 2 (L2) handover, and, more particularly, to a method and an apparatus to use FMIPv6 to trigger relatively faster L2 handover.

2. Description of the Related Art

Generally, an FMIPv6 technique includes a sending of a future prefix to a mobile node (MN) in advance. Thus, handoff latency is reduced when the MN moves from a previous access router (PAR) to a next access router (NAR).

FIG. 1 illustrates an MN performing a network handover operation from a PAR to a NAR. The PAR advertises a prefix 3ff1::/64. The NAR advertises a prefix 4ff1::/64. The MN is initially attached to access point 2 (AP2). The MN scans neighboring access points. FMIPv6 messages are exchanged between the MN and the PAR, and between the PAR and the NAR. Finally, the MN performs a handover from AP2 to access point 3 (AP3). Accordingly, an IPv6 care-of address of the MN changes from 3ff1::15 to 4ff1::15.

As shown in FIG. 1, (when the MN moves from AP2 to AP3,) an FMIPv6 handover comprises the following operations.

1) An MN sends a router solicitation for a proxy advertisement (RtSolPr) to a PAR to obtain information on neighboring ARs.

2) The MN receives a proxy router advertisement (PrRtAdv) message including one or more AP-identifications (ID) and/or one or more items of AR-information (Info) from the PAR.

3) The MN sends a fast binding update (FBU) message to the PAR.

4) The PAR sends a handover initiate (HI) message to an NAR.

5) The NAR sends a handover acknowledge (HAck) message to the PAR.

6) The PAR sends a fast binding acknowledgement (FBAck) message to a new link. If the FBU message has been sent from a previous link, the FBAck message is also optionally sent from the previous link.

7) The MN is attached to the NAR and then sends a fast neighbor advertisement (FNA) message to the NAR.

However, according to the above-described technique, when an MN moves from an AP2 to an AP3 during handover, the AP3 has no prior information on the MN. Therefore, a general “Association” [IEEE] process between AP3 and the MN must be undertaken. This causes an L2 handoff latency.

Related art references related to the present invention are provided below.

### SUMMARY OF THE INVENTION

Aspects of the present invention provide a method and an apparatus to minimize a handoff latency generated during a handover of a mobile node (MN).

According to an aspect of the present invention, there is provided a method and an apparatus for using fast mobile internet protocol version 6 (FMIPv6) to trigger faster layer 2 (L2) handover. The method and apparatus have following features.

The present invention relates to a method of using FMIPv6 messages during a predictive handover to provide for a reduction of the L2 handoff latency.

Accordingly, the present invention will describe a method and an apparatus to use FMIPv6 so as to trigger a relatively faster L2 handover of an MN from an initial access point associated with a previous access router (PAR) to a neighboring access point associated with a next access router (NAR). The method includes following operations:

(a1) the PAR sending the neighboring access point ID in a handover initiate (HI) message;

(a2) the PAR obtaining an IPv6 address of the neighboring access point from a handover acknowledge (HAck) message;

(a3) the PAR transferring the IPv6 address of the neighboring access point and an IPv6address of the MN to an initial access point;

(b1) the MN sending the neighboring access point ID in a fast binding update (FBU) message;

(c1) a NAR receiving the neighboring access point ID from the HI message;

(c2) the NAR sending the IPv6 address of the neighboring access point in the HAck message;

(d1) the initial access point obtaining the IPv6 address of the neighboring access point from the PAR;

(d2) the initial access point sending parameters specific to the MN directly to the neighboring access point, to cause the neighboring access point to allocate resources for the MN in advance; and

(e1) the neighboring access point receiving a message from the initial access point and then allocating the resources in advance for the MN.

First, the MN performs a scanning operation and obtains a neighboring access point ID. The MN sends a router solicitation for a proxy advertisement (RtSolPr) message to a PAR and the PAR sends a proxy router advertisement (PrRtAdv) message to the MN. The MN sends a fast binding update (FBU) message to the PAR. The neighboring access point ID is included in the FBU message. The PAR sends a HI message together with a context transfer and the neighboring access point ID. A NAR sends a HAck message together with an IPv6 address of a neighboring access point. The PAR informs an initial access point that the MN is trying to move to the neighboring access point. The IPv6 address of the neighboring access point is sent to the initial access point. The initial access point directly contacts the neighboring access point through its IPv6 address and then sends resource allocation parameters specific to the MN. The PAR sends an FBAck to the MN. The MN performs a handover.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a mobile node (MN) performing a network handover from a previous access router (PAR) to a next access router (NAR); and

FIG. 2 illustrates operations of a method of using fast mobile internet protocol version 6 (FMIPv6) to trigger faster layer 2 (L2) handover according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

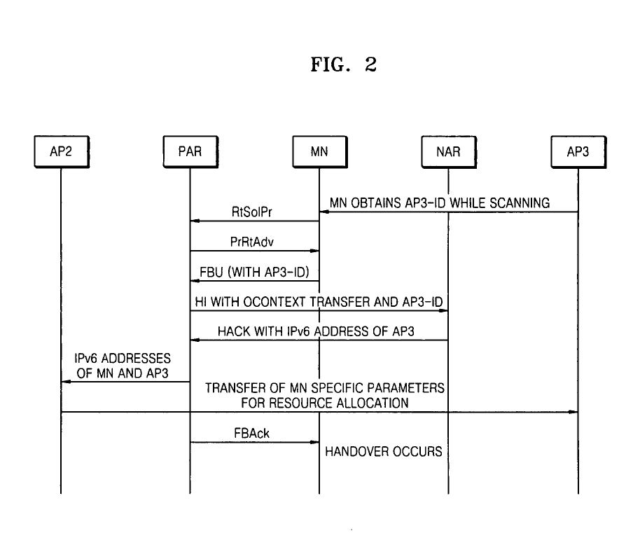

FIG. 2 illustrates operations of a method of using a relatively fast mobile internet protocol version 6 (FMIPv6) to trigger a relatively faster layer 2 (L2) handover according to an embodiment of the present invention. FIG. 2 illustrates control flow and data messages. Embodiments of the present invention comprise the following progressive operations.

1) A mobile node (MN) performs a scanning operation and obtains an access point 3 (AP3)-ID.

2) The MN sends a router solicitation for a proxy advertisement (RtSolPr) message to a previous access router (PAR).

3) The PAR sends a proxy router advertisement (PrRtAdv) message to the MN.

4) The MN sends a fast binding update (FBU) message to the PAR. The AP3-ID is included in the FBU message.

5) The PAR sends a handover initiate (HI) message together with a context transfer and the AP3-ID.

6) The NAR sends a handover acknowledge (HAck) message together with an IPv6 address of AP3.

7) The PAR informs access point 2 (AP2) regarding the MN trying to move to AP3. The IPv6 address of AP3 is sent to AP2.

8) AP2 contacts AP3 through IPv6 address thereof and then sends resource allocation parameters specific to the MN.

9) The PAR sends a fast binding acknowledgement (FBAck) message to the MN.

10) Then, the MN is able to immediately perform a handover.

MIPv6 enables an MN to maintain a connection to the internet when the MN moves from one access router to another, which is an operation that is referred to as a handover. During such a handover, the MN is unable to send or receive packets for a certain period due to link switching delay and IP protocol operations. Such handover latency resulting from standard MIPv6 procedures (i.e., motion detection, new care-of address configuration and binding updates), is often unacceptable for real-time traffic such as voice over IP. Reduction of handover latency is also beneficial for non real-time, throughput-sensitive applications. Indeed, an aspect of the present invention is to reduce link-switching latency (L2 handover latency) during network handover. To this end, aspects of the present invention reduce the L2 handoff latency, dictate that the present invention be compatible with existing standards, and are simple and relatively easily deployable.

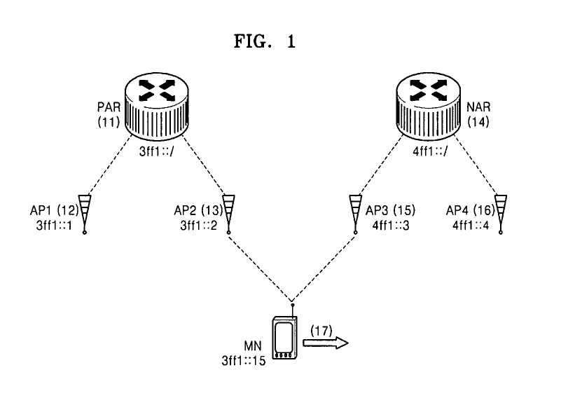

According to an embodiment of the present invention, a method of reducing L2 handoff latency while an MN performs a network handover is suggested. FIGS. 1 and 2 illustrate an exemplary scenario in which the present invention is utilized. With reference to FIGS. 1 and 2, progressive operations of an embodiment of the present invention are described below.

1) A mobile node (MN) performs a scanning operation and obtains an access point 3 (AP3)-ID.

2) The MN sends a router solicitation for proxy advertisement (RtSolPr) message to a previous access router (PAR).

3) The PAR sends a proxy router advertisement (PrRtAdv) message to the MN.

4) The MN sends a fast binding update (FBU) message to the PAR. The AP3-ID is included in the FBU message.

5) The PAR sends a handover initiate (HI) message together with a context transfer and the AP3-ID.

6) The NAR sends a handover acknowledge (HAck) message together with an IPv6 address of AP3.

7) The PAR informs access point 2 (AP2) that the MN is trying to move to AP3. The IPv6 address of AP3 is sent to AP2.

8) AP2 contacts AP3 through an IPv6 address thereof and, then, sends resource allocation parameters specific to the MN to the AP3.

9) The PAR sends a fast binding acknowledgement (FBAck) message to the MN.

10) The MN is then able to immediately perform a handover.

According to an aspect of the present invention as is described above, packet loss is reduced during an ongoing session of an MN while the MN performs a handover, and L2 handoff latency of the MN is also reduced. Re-configuration or support of v6 routers is not required. Also, a method according to aspects of the present invention may be realized easily and be embodied with a minimum modification of a conventional apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to use FMIPv6 (fast mobile internet protocol version 6) messages during a predictive handover of a mobile node in order to reduce a handoff latency of the mobile node, the apparatus comprising:
an initial access point that directly sends a message including resource allocation parameters, which are specific to the mobile node, to a neighboring access point in order to allocate resources of the neighboring access point for the mobile node in advance, wherein the neighboring access point receives the message from the initial access point and, then, allocates the resources in advance for use with the mobile node.

2. The apparatus according to claim 1, wherein the initial access point directly contacts the neighboring access point through an IPv6 address of the initial access point and, then, sends the resource allocation parameters specific to the mobile node.

3. A previous access router to use FMIPv6 to trigger a relatively fast layer 2 handover of a mobile node, the previous access router comprising:
means for sending a neighboring access point ID in a handover initiate message; and
means for obtaining an IPv6 address of a neighboring access point from a handover acknowledge message.

4. The previous access router according to claim 3, wherein the previous access router informs an initial access point that the mobile node is moving to the neighboring access point, wherein the IPv6 address of the neighboring access point is sent to the initial access point.

5. A next access router to use FMIPv6 to trigger a relatively fast layer 2 handover of a mobile node from an initial access point related to a previous access router to a neighboring access point related to the next access router, the next access router comprising:
means for receiving a neighboring access point ID from a handover initiate message; and
means for sending an IPv6 address of the neighboring access point in a handover acknowledge message.

6. A method of using FMIPv6 during a predictive handover in order to reduce a handoff latency of a mobile node, comprising;
a initial access point to send parameters specific to the mobile node directly to a neighboring access point to cause the neighboring access point to allocate resources for the mobile node in advance, wherein the neighboring access point receives the specific parameters from the initial access point and, then, allocates the resources for the mobile node in advance.

7. A method of using FMIPv6 to trigger a relatively fast layer 2 handover of a mobile node from an initial access point related to a previous access router to a neighboring access point related to a next access router, comprising:
the previous access router sending a neighboring access point ID in a handover initiate message;
the previous access router obtaining an IPv6 address of the neighboring access point from a handover acknowledge message;
the previous access router transferring the IPv6 address of the neighboring access point and an IPv6 address of the mobile node to the initial access point;
the mobile node sending the neighboring access point ID in a fast binding update message;
a next access router receiving the neighboring access point ID from the handover initiate message;
the next access router sending the IPv6 address of the neighboring access point in the handover acknowledge message;
the initial access point obtaining the IPv6 address of the neighboring access point from the previous access router;
the initial access point sending a message including parameters specific to the mobile node directly to the neighboring access point, to cause the neighboring access point to allocate resources for the mobile node in advance; and
the neighboring access point receiving the message from the initial access point and then allocating the resources in advance for the mobile node.

8. The method according to claim 7, wherein the mobile node sends the fast binding update message to the previous access router, and wherein the neighboring access point ID is included in the fast binding update.

9. The method according to claim 7, wherein the previous access router sends the handover initiate message together with a context transfer and the neighboring access point ID.

10. The method according to claim 7, wherein the next access router sends the handover acknowledge message together with the IPv6 address of the neighboring access point

11. The method according to claim 7, wherein the previous access router informs the initial access point that the mobile node is moving to the neighboring access point, and wherein the IPv6 address of the neighboring access point is sent to the initial access point.

12. The method according to claim 7, wherein the initial access point directly contacts the neighboring access point through an IPv6 address of the initial access point and then sends resource allocation parameters specific to the mobile node.

13. An apparatus to use FMIPv6 (fast mobile internet protocol version 6) messages during a predictive handover of a mobile node from a previous access router to a next access router in order to minimize a handoff latency of the handover of the mobile node, the apparatus comprising:
an initial access point, corresponding to the previous access router, that directly sends resource allocation parameters specific to the mobile node to a neighboring access point, corresponding to the next access router, in order to cause the neighboring access point to allocate resources thereof to the mobile node in advance and in accordance with the resource allocation parameters.

14. The apparatus according to claim 13, wherein the initial access point directly contacts the neighboring access point through an IPv6 address of the initial access point and, then, sends the resource allocation parameters specific to the mobile node.

15. A previous access router to use FMIPv6 to trigger a relatively fast layer 2 handover of a mobile node, the previous access router comprising:
means for sending a neighboring access point ID in a handover initiate message; and
means for obtaining an IPv6 address of a neighboring access point from a handover acknowledge message, wherein the previous access router informs an initial access point that the mobile node is moving to the neighboring access point, and wherein the IPv6 address of the neighboring access point is sent to the initial access point.

16. A method of using FMIPv6 during a predictive handover of a mobile node from an initial access point of a previous access router to a neighboring access point of a next access router in order to reduce a handoff latency of the mobile node, wherein the initial access point sends resource allocation parameters specific to the mobile node directly to the neighboring access point to cause the neighboring access point to allocate resources for the mobile node in advance in accordance with the resource allocation parameters.

17. A method of using FMIPv6 to trigger a relatively fast layer 2 handover of a mobile node from an initial access point related to a previous access router to a neighboring access point related to a next access router, comprising:
the previous access router sending a neighboring access point ID in a handover initiate message;
the previous access router obtaining an IPv6 address of the neighboring access point from a handover acknowledge message;
the previous access router transferring the IPv6 address of the neighboring access point and an IPv6 address of the mobile node to the initial access point;
the mobile node sending the neighboring access point ID in a fast binding update message;
a next access router receiving the neighboring access point ID from the handover initiate message;
the next access router sending the IPv6 address of the neighboring access point in the handover acknowledge message;
the initial access point obtaining the IPv6 address of the neighboring access point from the previous access router;
the initial access point sending resource allocation parameters specific to the mobile node directly to the neighboring access point to cause the neighboring access point to allocate resources for the mobile node in accordance with the resource allocation parameters; and
the neighboring access point receiving the resource allocation parameters from the initial access point and, then, allocating the resources.

18. The method according to claim 17, wherein the mobile node sends the fast binding update message to the previous access router, and wherein the neighboring access point ID is included in the fast binding update.

19. The method according to claim 17, wherein the previous access router sends the handover initiate message together with a context transfer and the neighboring access point ID.

20. The method according to claim 17, wherein the next access router sends the handover acknowledge message together with the IPv6 address of the neighboring access point

21. The method according to claim 17, wherein the previous access router informs the initial access point that the mobile node is moving to the neighboring access point, and wherein the IPv6 address of the neighboring access point is sent to the initial access point.

22. The method according to claim 17, wherein the initial access point directly contacts the neighboring access point through an IPv6 address of the initial access point and then sends resource allocation parameters specific to the mobile node.

23. A method of conducting an ongoing session of a mobile node (MN) while the MN performs a handover from a previous access router to a next access router in which packet loss and L2 handoff latency of the MN are reduced and in which a re-configuration or support of v6 routers is not required.
